(19) United States
(12) Patent Application Publication
(10) Pub. No.: US 2012/0004831 A1
(43) Pub. Date: Jan. 5, 2012

(54) CONTROLLER FOR INTERNAL COMBUSION ENGINE

(75) Inventors: Hiroshi Miyagawa, Aichi-gun (JP); Makoto Koike, Toyota-shi (JP)

(73) Assignee: TOYOTA JIDOSHA KABUSHIKI KAISHA, TOYOTA-SHI, AICHI-KEN (JP)

(21) Appl. No.: 13/256,854

(22) PCT Filed: Mar. 25, 2009
(86) PCT No.: PCT/JP2009/055913

§ 371 Date: Sep. 15, 2011

(51) Int. Cl. F02D 41/26

(52) U.S. Cl. 701/103

(57) ABSTRACT

An internal combustion engine uses, as the fuel, ammonia and gasoline (supporting fuel) for promoting the combustion of the ammonia. The ammonia is injected from an ammonia injector into an intake pipe, and the gasoline is injected from a gasoline injector into the intake pipe. An electronic control unit for drivingly controlling the ammonia injector and the gasoline injector stops the injection of the ammonia from the ammonia injector and allows the injection of the gasoline from the gasoline injector when the temperature of a cooling water of the internal combustion engine detected by a cooling water temperature sensor is equal to or lower than a predetermined temperature.

### TECHNICAL FIELD

The present invention relates to a controller for an internal combustion engine, and more particularly to an apparatus which performs control of an internal combustion engine that utilizes, as a fuel, ammonia and a combustion-supporting fuel for promoting combustion of the ammonia.

### BACKGROUND ART

Internal combustion engines which utilize ammonia (NH₃) as a fuel other than a petroleum fuel have been proposed. Technologies related to these internal combustion engines are disclosed in Patent Literature 1 and Non-Patent Literature 1 indicated below. While the use of ammonia as a fuel of an internal combustion engine allows reduction in discharge of carbon dioxide (CO₂), when compared with petroleum fuels such as gasoline, ammonia has a slower combustion rate and is more difficult to ignite. In Patent Literature 1, heat of exhaust gas after combustion is used to decompose ammonia, thereby generating hydrogen gas, and the hydrogen gas is introduced into an auxiliary chamber to cause initial combustion, thereby promoting combustion of ammonia within a combustion chamber.
Patent Literature 1: JP 5-332152 A
Non-Patent Literature 1: Shawn M. Grannenell et al. “THE OPERATING FEATURES OF A STOICHIOMETRIC, AMMONIA AND GASOLINE DUAL FUELED SPARK IGNITION ENGINE”, IMECE 2006-13048, 2006 ASME International Mechanical Engineering Congress and Exposition, 2006

### DISCLOSURE OF THE INVENTION

### Technical Problems

In an internal combustion engine, in order to perform a stable operation while suppressing variations in combustion, it is necessary to burn a fuel at a combustion rate which is sufficient for completing the combustion while a piston is located near top dead center. However, the combustion rate of a fuel is affected not only by the type of the fuel but also by the temperature of gas within the cylinder. The combustion rate is low when the gas temperature within the cylinder is low. In an internal combustion engine which utilizes, as the fuel, ammonia and a fuel for supporting combustion, when the temperature of gas within the cylinder is low, the ratio of usage amount of ammonia, whose combustion rate is slow, becomes excessive, leading to an increase in variations of combustion and making it difficult to perform a stable operation.

Further, because ammonia gas has a strong odor, in the case of using ammonia and a combustion-supporting fuel as the fuel of an internal combustion engine, it is desirable to purify unburned ammonia contained in exhaust gas which is discharged from within the cylinder, by means of an exhaust purifier. However, the performance of the exhaust purifier for purifying the unburned ammonia is affected by the temperature of the exhaust gas passing through the exhaust purifier, and the efficiency of purification of ammonia abruptly decreases when the temperature of exhaust gas is below a threshold value. Consequently, if ammonia is used when the temperature of exhaust gas is low, it becomes difficult to suppress emission of unburned ammonia.

In Patent literature 1, the distribution of usage of ammonia and hydrogen is not indicated, which leads to a possibility of making it difficult to achieve a stable operation of the internal combustion engine with suppressed variations of combustion when the temperature of gas within the cylinder is low. Further, there is also a possibility that, when the temperature of exhaust gas is low, it is difficult to suppress emission of unburned ammonia.

An advantage of the present invention is to provide a controller for an internal combustion engine that realizes a stable operation with suppressed variations of combustion of an internal combustion engine. Another advantage of the present invention is to provide a controller for an internal combustion engine that suppresses emission of unburned ammonia in a stable manner.

### Solution to Problems

A controller for an internal combustion engine according to the present invention is an apparatus which performs control of an internal combustion engine that utilizes, as a fuel, ammonia and a combustion-supporting fuel for promoting combustion of the ammonia, and includes a cooling liquid temperature acquiring unit which acquires a temperature of a cooling liquid for the internal combustion engine, and a fuel controlling unit which inhibits use of ammonia when the temperature of the cooling liquid acquired by the cooling liquid temperature acquiring unit is a predetermined temperature or lower.

According to the present invention, by inhibiting the use of ammonia when the temperature of the cooling liquid for the internal combustion engine is a predetermined temperature or lower, a decrease in the combustion rate of the fuel can be suppressed, so that a stable operation with suppressed variations of combustion of the internal combustion engine can be realized.

Further, a controller for an internal combustion engine according to the present invention is an apparatus which performs control of an internal combustion engine that utilizes, as a fuel, ammonia and a combustion-supporting fuel for promoting combustion of the ammonia, and includes a fuel controlling unit that inhibits use of ammonia during start of the internal combustion engine.

According to the present invention, by inhibiting the use of ammonia during the start of the internal combustion engine, a stable operation with suppressed variations of combustion of the internal combustion engine can be realized, and also emission of unburned ammonia can be suppressed in a stable manner.

Further, a controller for an internal combustion engine according to the present invention is an apparatus which performs control of an internal combustion engine that utilizes, as a fuel, ammonia and a combustion-supporting fuel for promoting combustion of the ammonia and purifies ammonia contained in exhaust gas by an emission purification device, and includes an exhaust temperature acquiring unit that acquires a temperature of exhaust gas before or after the exhaust purification device and a fuel controlling unit that inhibits use of ammonia when the temperature of exhaust gas acquired by the exhaust temperature acquiring unit is a predetermined temperature or lower.

According to the present invention, by inhibiting the use of ammonia when the temperature of exhaust gas before or after the exhaust purification device is the predetermined temperature or lower, emission of unburned ammonia can be suppressed in a stable manner.

In accordance with one aspect of the present invention, the combustion-supporting fuel preferably includes any one or more of hydrogen, a hydrocarbon fuel, and an alcohol fuel.

### BRIEF DESCRIPTION OF THE DRAWINGS

FIG. 1 A view schematically illustrating a structure of a controller and an internal combustion engine to be controlled in accordance with Embodiment 1 of the present invention.

FIG. 2 A view illustrating a result of a change of the combustion rate obtained by calculation when the ratio of usage of a combustion-supporting fuel is changed with respect to ammonia.

FIG. 3 A view illustrating a result of a characteristic of the combustion rate with respect to the temperature of mixture, which is obtained by calculation while changing the ratio of injection of ammonia and gasoline.

FIG. 4 A view illustrating an example time series variation in the temperature of cooling water and the ratio of injection of ammonia in the controller according to Embodiment 1 of the present invention.

FIG. 5 A view schematically illustrating a structure of a controller and an internal combustion engine to be controlled in accordance with Embodiment 2 of the present invention.

FIG. 6 A view illustrating an experimental result of a characteristic of the efficiency of purification of ammonia with respect to the temperature of catalyst-in gas, concerning an exhaust catalyst which purifies unburned ammonia.

FIG. 7 A view illustrating an example time series variation in the temperature of exhaust gas and the ratio of injection of ammonia in the controller according to Embodiment 2 of the present invention.

FIG. 8 A view illustrating an experimental result of the effect of suppressing emission of unburned ammonia according to Embodiment 2 of the present invention.

FIG. 9 A view schematically illustrating a structure of a controller and an internal combustion engine to be controlled in accordance with Embodiment 3 of the present invention.

### REFERENCE SIGNS LIST

10 internal combustion engine, 11 cylinder, 12 ammonia tank, 14 gasoline tank, 15 diesel fuel tank, 20 intake pipe, 21 exhaust pipe, 22 ammonia injector, 24 gasoline injector, 25 diesel fuel injector, 30 exhaust catalyst, 31 ammonia decomposer, 33 decomposed gas injection valve, 34 decomposed gas storage unit, 40 electronic control unit, 42 cooling water temperature sensor, 44 exhaust temperature sensor.

### BEST MODE FOR CARRYING OUT THE INVENTION

Preferred embodiments of the present invention will be described with reference to the drawings.

### Embodiment 1

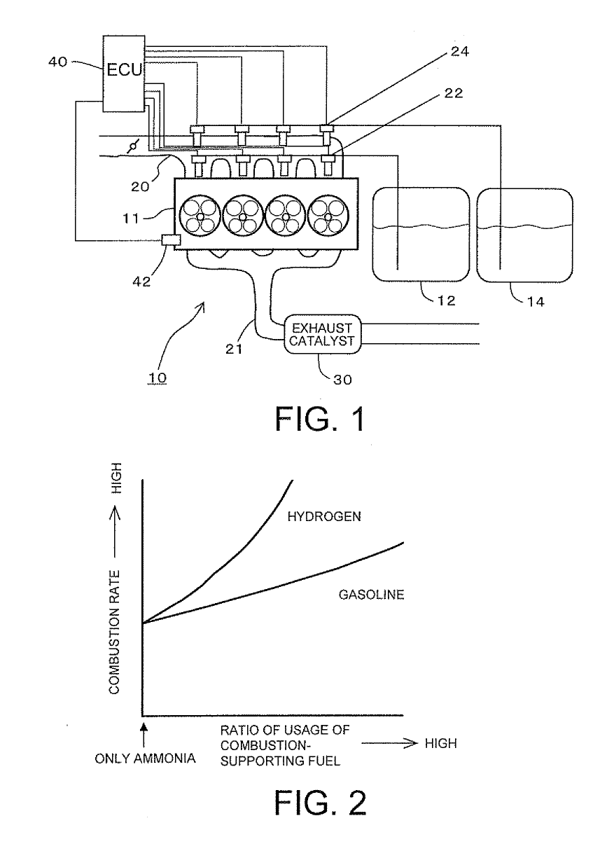

FIG. 1 is a view schematically illustrating the structure of a controller according to the present embodiment together with an internal combustion engine to be controlled. The internal combustion engine utilizes, as a fuel, ammonia (a first fuel) and a combustion-supporting fuel (a second fuel) for promoting combustion of the ammonia. FIG. 1 illustrates an example in which gasoline (a hydrocarbon fuel) is used as the combustion-supporting fuel.

Ammonia (NH₃) is stored in an ammonia tank 12 and gasoline is stored in a gasoline tank 14. The ammonia stored in the ammonia tank 12 is supplied to ammonia injectors 22 by a pump, and the gasoline stored in the gasoline tank 14 is supplied to gasoline injectors 24 by a pump. The ammonia injectors 22 located within an intake pipe 20 inject the ammonia supplied from the ammonia tank 12 into the intake pipe 20, and the gasoline injectors 24 located within the intake pipe 20 inject the gasoline supplied from the gasoline tank 14 into the intake pipe 20. The ammonia and gasoline injected from the ammonia injectors 22 and the gasoline injectors 24, respectively, are introduced into a cylinder 11 along with air during the intake stroke. The internal combustion engine 10 combusts a mixture of the fuels (ammonia and gasoline) and air within the cylinder 11 to thereby generate power. The exhaust gas after the combustion is discharged into an exhaust pipe 21 from within the cylinder 11 during the exhaust stroke, and is purified by an exhaust catalyst 30 which is provided as an exhaust purifier. The exhaust gas after the combustion contains nitrogen oxide (NOx), unburned ammonia, and the like, and the nitrogen oxide (NOx), unburned ammonia, and the like are purified by the exhaust catalyst 30. Further, a cooling water temperature sensor 42 for detecting a temperature Tw of cooling water (a cooling liquid) for the internal combustion engine 10 is provided in the cylinder.

While FIG. 1 illustrates an example in which ammonia and the combustion-supporting fuel (gasoline) are injected into the intake pipe 20, it is also possible to dispose the ammonia injectors 22 within the cylinder 11 for injecting ammonia directly into the cylinder 11 and/or to dispose the gasoline injectors 24 within the cylinder 11 for injecting gasoline directly into the cylinder 11. Further, it is also possible to ignite the air-fuel mixture within the cylinder 11 by spark discharge of a spark plug to burn the air-fuel mixture within the cylinder 11 by flame propagation, or to burn the fuels (ammonia and the combustion-supporting fuel) within the cylinder 11 by compression auto-ignition.

An electronic control unit (ECU) 40 is configured as a microprocessor which is formed mainly by a CPU, and includes aROM for storing a processing program, a RAM for temporarily storing data, and an input/output port. A signal indicative of the temperature Tw of cooling water for the internal combustion engine 10 which is detected by the cooling water temperature sensor 42 is input to the electronic control unit 40 via an input port. Further, a signal indicative of the rotation speed of the internal combustion engine 10, a signal indicative of the degree of opening of a throttle, or the like, detected by sensors which are not illustrated, are also input to the electronic control unit 40 via the input port. On the other hand, an ammonia injection control signal for performing driving control of the ammonia injectors 22, a gasoline injection control signal for performing driving control of the gasoline injectors 24, or the like, are output from the electronic control unit 40 via the output port. The electronic control unit 40 computes a target total injection amount and a target distribution of injection of the fuels based on the rotation speed of the internal combustion engine 10 and the degree of opening of the throttle, and controls driving of the ammonia injectors 22 and the gasoline injectors 24, respectively, such that the total injection amount and the distribution of injection of the fuels correspond to the target total injection amount and the target distribution of injection, respectively, thereby controlling the injection amount (usage amount) of ammonia and the injection amount (usage amount) of gasoline. Consequently, the distribution of injection (distribution of usage) of ammonia and gasoline (the combustion-supporting fuel) can be controlled.

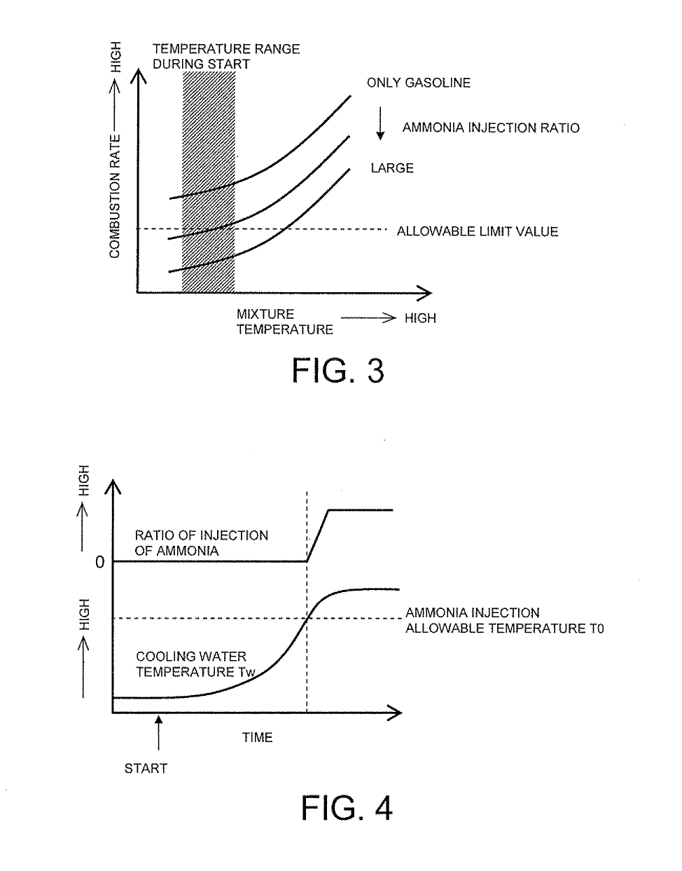

In an internal combustion engine, in order to perform a stable operation while suppressing variations in combustion, it is necessary to burn the fuel at a combustion rate which is sufficient for completing the combustion while the piston is located near top dead center. While ammonia is a substance whose combustion rate is slower and which is more difficult to ignite when compared to hydrocarbon fuels such as gasoline, combustion of ammonia can be promoted by burning a combustion-supporting fuel (which is gasoline in the example illustrated in FIG. 1) in addition to ammonia within the cylinder 11. FIG. 2 illustrates a result of calculation of a change in the combustion rate when the ratio of usage of the combustion-supporting fuel is changed with respect to ammonia. Specifically, FIG. 2 illustrates a result of calculation of the combustion rate when gasoline is used as the combustion-supporting fuel and a result of calculation of the combustion rate when hydrogen is used as the combustion-supporting fuel. As illustrated in FIG. 2, it can be understood that the combustion rate can be increased by increasing the ratio of usage of the combustion-supporting fuel (i.e. by decreasing the ratio of usage of ammonia). However, the combustion rate of a fuel is affected not only by a type of the fuel but also by the temperature of gas within the cylinder 11 (the temperature of mixture). A calculation result of a characteristic of the combustion rate with respect to the temperature of mixture, which is examined while changing the ratio of injection of ammonia and gasoline (combustion-supporting fuel), is illustrated in FIG. 3. In the calculation result illustrated in FIG. 3, when the combustion rate is below the allowable limit value, the variations in combustion increase to make a stable operation of the internal combustion engine difficult.

As illustrated in FIG. 3, it can be seen that at any ratio of injection of ammonia, the lower the temperature of mixture, the lower the combustion rate. Further, it can also be understood that the higher the ratio of injection of ammonia, the lower the combustion rate, and that under the condition that the ratio of injection of ammonia is a certain degree or higher, when the temperature of mixture is below a certain threshold value, the combustion rate is below the allowable limit value. FIG. 3 also illustrates a range of the temperature of mixture during the start (during cold start) of the internal combustion engine. As described above, when the temperature of mixture is low, such as during the start of the internal combustion engine, the compression temperature is low and increasing the combustion rate is difficult. Further, as ammonia has great latent heat of evaporation, when ammonia is injected into the intake pipe 20 or the cylinder 11, the compression temperature is further lowered. Therefore, according to the present embodiment, during the start of the internal combustion engine 10, the electronic control unit 40 inhibits use of ammonia and allows use of the combustion-supporting fuel (gasoline) only. Specifically, the electronic control unit 40 stops injection of ammonia from the ammonia injector 22 and only allows injection of gasoline from the gasoline injector 24. The electronic control unit 40 inhibits the use of ammonia and uses only the combustion-supporting fuel until completion of warm-up of the internal combustion engine 10. The completion of warm-up of the internal combustion engine 10 can be easily determined based on the temperature Tw of cooling water. It is possible to determine the completion of warm-up of the internal combustion engine 10 when the temperature Tw of cooling water for the internal combustion engine 10 which is acquired by the cooling water temperature sensor 42 exceeds a predetermined temperature T0, for example.

FIG. 4 illustrates the time series variations of the temperature Tw of cooling water and the ratio of injection of ammonia. As illustrated in FIG. 4, during the start (during cold start) of the internal combustion engine 10, the temperature Tw of cooling water is equal to an ammonia injection allowable temperature T0 or lower, and the electronic control unit 40 stops injection of ammonia from the ammonia injector 22 (inhibits the use of ammonia) and only allows the gasoline injector 24 to inject gasoline. In other words, the electronic control unit 40 controls the ratio of injection of ammonia to 0%. Then, even after the start of the internal combustion engine 10, while the temperature Tw of cooling water acquired by the cooling water temperature sensor 42 is the ammonia injection allowable temperature T0 or lower, the electronic control unit 40 stops injection of ammonia from the ammonia injector 22, and allows injection of gasoline from the gasoline injector 24. If the temperature Tw of cooling water increases to exceed the ammonia injection allowable temperature T0, the electronic control unit 40 then allows the use of ammonia, and causes the ammonia injector 22 and the gasoline injector 24 to inject ammonia and gasoline, respectively. Then, as illustrated in FIG. 4, the electronic control unit 40 gradually increases the ratio of injection of ammonia with the rise of the temperature Tw of cooling water. In this manner, by inhibiting injection of ammonia until completion of warm-up of the internal combustion engine 10, the combustion rate which is at the allowable limit value or higher can be obtained even when the temperature of mixture is low as illustrated in FIG. 3. After the completion of warm-up of the internal combustion engine 10, as the temperature of mixture is sufficiently increased, it is possible to obtain the combustion rate at the allowable limit value or higher even if the ratio of injection of ammonia is increased.

As described above, according to the present embodiment, by inhibiting injection of ammonia and allowing injection of the combustion-supporting fuel only during the start of the internal combustion engine 10, a decrease in the combustion rate of the fuel can be suppressed, so that stable start of the internal combustion engine 10 can be performed and startability of the internal combustion engine 10 can be enhanced. Further, by inhibiting injection of ammonia and allowing only injection of the combustion-supporting fuel when the temperature Tw of cooling water is the ammonia injection allowable temperature T0 or lower, a stable operation with suppressed variations of combustion of the internal combustion engine 10 can be realized. After the temperature Tw of cooling water exceeds the ammonia injection allowable temperature T0, by allowing the injection of ammonia, the usage efficiency of ammonia can be increased while suppressing the variations of combustion.

### Embodiment 2

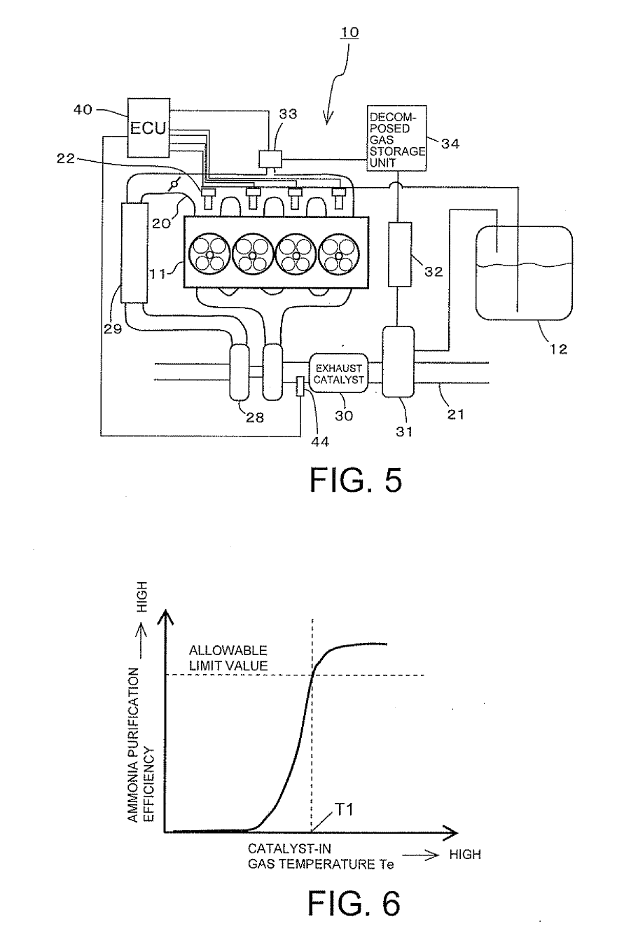

FIG. 5 schematically illustrates the structure of a controller according to Embodiment 2 of the present invention together with an internal combustion engine 10 to be controlled. In the following description concerning Embodiment 2, elements similar or corresponding to those in Embodiment 1 are designated by the same numerals and description thereof will not be repeated.

FIG. 5 illustrates an example in which hydrogen (H₂) is used as a combustion-supporting fuel. Specifically, FIG. 5 illustrates an example of a turbocharged engine including a turbocharger 28 and an intercooler 29, in which an ammonia decomposition unit 31 is disposed in the exhaust pipe 21 downstream of the exhaust catalyst 30. The ammonia decomposition unit 31 uses heat of the exhaust gas after combustion which is discharged into the exhaust pipe 21 to decompose ammonia supplied from the ammonia tank 12, thereby producing hydrogen. The hydrogen (decomposed gas) produced by the ammonia decomposition unit 31 is cooled by a cooler 32 and is then supplied to a decomposed gas storage unit 34. As the decomposed gas storage unit 34, a hydrogen storage alloy or a pressure tank can be used. Hydrogen stored in the decomposed gas storage unit 34 is injected from the decomposed gas injection valve 33 into the intake pipe 20. According to the present embodiment, it is also possible to produce hydrogen by reforming ammonia by means of plasma, for example.

An exhaust temperature sensor 44 for detecting the temperature Te of exhaust gas of the internal combustion engine 10 is provided in the exhaust pipe 21. In the example illustrated in FIG. 5, the exhaust temperature sensor 44 is disposed at a location on the upstream side of the exhaust catalyst 30 in the exhaust pipe 21 and therefore detects the temperature Te of exhaust gas before (upstream of) the exhaust catalyst 30. However, it is also possible to dispose the exhaust temperature sensor 44 at a location on the downstream side of the exhaust catalyst 30 in the exhaust pipe 21 to detect the temperature Te of exhaust gas after (downstream of) the exhaust catalyst 30. A signal indicative of the temperature Te of the exhaust gas before (or after) the exhaust catalyst 30 which is detected by the exhaust temperature sensor 44 is input, via the input port, to the electronic control unit 40. The electronic control unit 40 performs driving control of the ammonia injector 22 and the decomposed gas injection valve 33, respectively, to control the amount of injection of ammonia and the amount of injection of hydrogen, thereby controlling the distribution of injection (distribution of usage) of ammonia and hydrogen.

Because ammonia is a gas having a strong odor, it is desirable to purify the unburned ammonia contained in the exhaust gas which is emitted from within the cylinder 11, by means of the exhaust catalyst 30. However, the performance of the exhaust catalyst 30 for purifying the unburned ammonia is affected by the temperature Te of the exhaust gas. FIG. 6 illustrates an experimental result of the characteristic of the efficiency of purification of ammonia with respect to the temperature Te of catalyst-in gas, concerning the exhaust catalyst 30. As illustrated in FIG. 6, it can be understood that, when the temperature Te of catalyst-in gas is below a threshold value T1 (e.g. a value which is approximately 250° C.), the efficiency of purification of ammonia rapidly lowers below the allowable limit value and the exhaust catalyst 30 cannot exhibit the activity with respect to ammonia. As described above, when the temperature Te of the exhaust gas is lower than the temperature at which activities with respect to purification of ammonia can be exhibited, such as during the start (during the cold start) of the internal combustion engine, the efficiency of purification of unburned ammonia by means of the exhaust catalyst 30 is reduced. Therefore, according to the present embodiment, during the start of the internal combustion engine 10, the electronic control unit 40 inhibits the use of ammonia and allows the use of the combustion-supporting fuel (hydrogen) only. More specifically, the electronic control unit 40 stops injection of ammonia from the ammonia injector 22 and allows injection of hydrogen stored in the decomposed gas storage unit 34 from the decomposed gas injection valve 33. The electronic control unit 40 inhibits the use of ammonia and allows only the use of the combustion-supporting fuel until completion of warm-up of the exhaust catalyst 30. The completion of warm-up of the exhaust catalyst 30 can be easily determined from the temperature Te of the exhaust gas before (or after) the exhaust catalyst 30. When the temperature Te of the exhaust gas before (or after) the exhaust catalyst 30 which is detected by the exhaust temperature sensor 44 exceeds a predetermined temperature T1, for example, it can be determined that warm-up of the exhaust catalyst 30 is completed.

FIG. 7 illustrates a time series variation of the temperature Te of exhaust gas and the ratio of injection of ammonia. As illustrated in FIG. 7, during the start (cold start) of the internal combustion engine 10, the temperature Te of exhaust gas is equal to or lower than the ammonia injection allowable temperature T1, and the electronic control unit 40 stops injection of ammonia from the ammonia injector 22 (inhibits the use of ammonia) and allows injection of hydrogen from the decomposed gas injection valve 33. In other words, the electronic control unit 40 sets the ratio of injection of ammonia to 0%. Then, even after the start of the internal combustion engine 10, while the temperature Te of exhaust gas which is detected by the exhaust temperature sensor 44 is equal to or lower than the ammonia injection allowable temperature T1, the electronic control unit 40 stops injection of ammonia from the ammonia injector 22 and allows injection of hydrogen from the decomposed gas injection valve 33. When the temperature Te of exhaust gas increases and exceeds the ammonia injection allowable temperature T1, the electronic control unit 40 then allows the use of ammonia and causes the ammonia injector 22 and the decomposed gas injection valve 33 to inject ammonia and hydrogen, respectively. Then, as illustrated in FIG. 7, the electronic control unit 40 gradually increases the ratio of injection of ammonia with the rise of the temperature Te of exhaust gas. As described above, by inhibiting injection of ammonia until completion of warm-up of the exhaust catalyst 30, even when the efficiency of purification of ammonia by the exhaust catalyst 30 is lower than the allowable limit value, it is possible to prevent emission of unburned ammonia. After the completion of warm-up of the exhaust catalyst 30, it is possible to obtain the efficiency of ammonia purification which is equal to or greater than the allowable limit value even when the ratio of injection of ammonia is increased, so that emission of unburned ammonia can be suppressed.

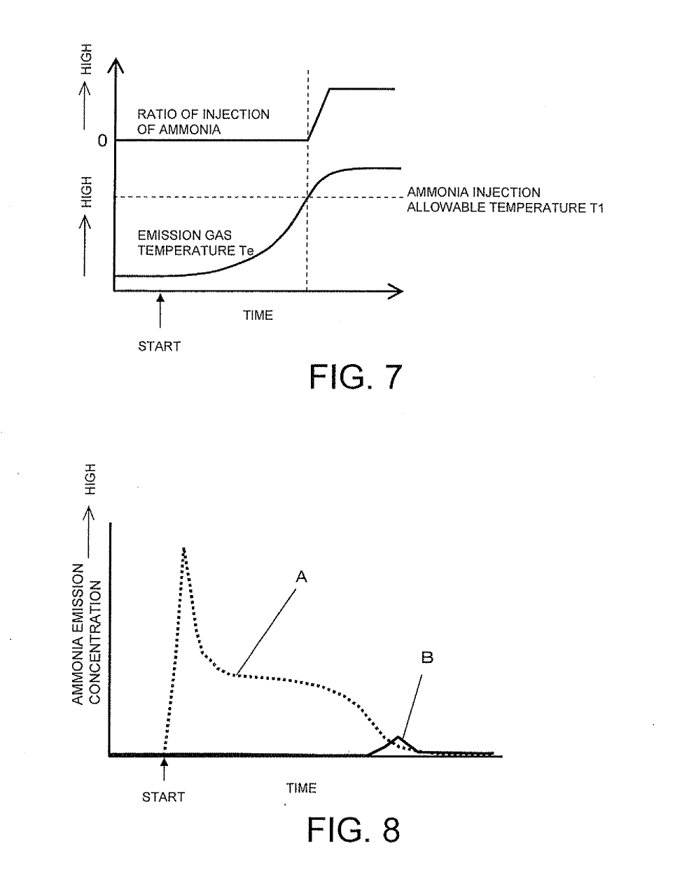

FIG. 8 illustrates an experimental result of the effect of suppression of emission of unburned ammonia according to the present embodiment. In FIG. 8, the horizontal axis indicates time and the vertical axis indicates the concentration of unburned ammonia emission from the exhaust catalyst 30. Further, in FIG. 8, A indicates the concentration of ammonia emission when control for inhibiting injection of ammonia is not performed during the start of the internal combustion engine, and B indicates the concentration of ammonia emission when control for inhibiting injection of ammonia is performed during the start of the internal combustion engine. As illustrated by A of FIG. 8, when control for inhibiting injection of ammonia during the start of the internal combustion engine is not performed, the concentration of emission of unburned ammonia increases, especially immediately after the start of the internal combustion engine. On the other hand, according to the present embodiment, by performing control for inhibiting injection of ammonia during the start of the internal combustion engine, it can be understood that it is possible to significantly reduce the concentration of emission of unburned ammonia as illustrated by B in FIG. 8.

As described above, according to the present embodiment, by inhibiting injection of ammonia and allowing injection of the combustion-supporting fuel during the start of the internal combustion engine 10, it is possible to prevent emission of unburned ammonia when the efficiency of purification of ammonia by the exhaust catalyst 30 is low. Further, it is also possible to prevent emission of unburned ammonia when the efficiency of purification of ammonia by the exhaust catalyst 30 is low, by inhibiting injection of ammonia and allowing only injection of the combustion-supporting fuel when the temperature Te of exhaust gas is the ammonia injection allowable temperature T1 or lower. As such, emission of unburned ammonia can be suppressed in a stable manner. After the temperature Te of exhaust gas exceeds the ammonia injection allowable temperature T1, injection of ammonia is then allowed so that the usage efficiency of ammonia can be increased while suppressing emission of unburned ammonia.

Further, when hydrogen is used as the combustion-supporting fuel, because the temperature Te of exhaust gas can be easily increased by performing retarded combustion, it is possible to accelerate the warm-up of the exhaust catalyst 30. Consequently, injection of ammonia can be started at an earlier timing after the start of the internal combustion engine, so that the usage efficiency of ammonia can be further enhanced.

According to the present embodiment, as in Embodiment 1, when the temperature Tw of cooling water which is detected by the cooling water temperature sensor 42 is equal to or less than the ammonia injection allowable temperature T0, the electronic control unit 40 can stop injection of ammonia from the ammonia injector 22 and allows injection of hydrogen from the decomposed gas injection valve 33. Further, in Embodiment 1, as in Embodiment 2, when the temperature Te of exhaust gas which is detected by the exhaust temperature sensor 44 is equal to or less than the ammonia injection allowable temperature T1, the electronic control unit 40 can stop injection of ammonia from the ammonia injector 22 and allows injection of gasoline from the gasoline injector 24.

### Embodiment 3

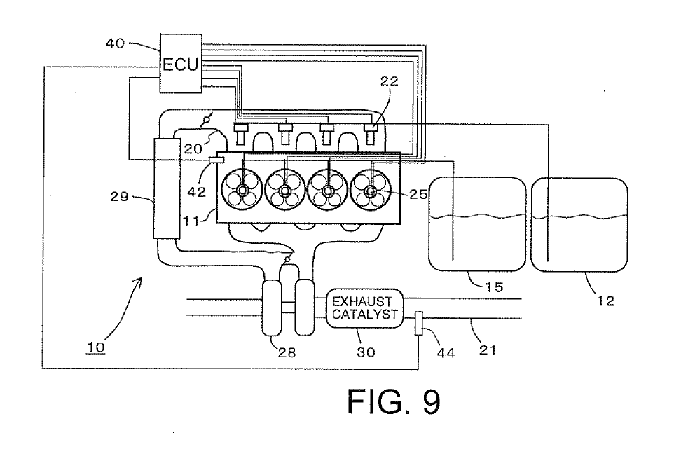

FIG. 9 schematically illustrates the structure of a controller according to Embodiment 3 of the present invention together with an internal combustion engine 10 to be controlled. In the following description concerning Embodiment 3, elements similar or corresponding to those in Embodiments 1 and 2 are designated by the same numerals and description thereof will not be repeated.

FIG. 9 illustrates an example in which diesel fuel (hydrocarbon fuel) is used as a combustion-supporting fuel. The diesel fuel stored in a diesel fuel tank 15 is injected into the cylinder 11 from a diesel fuel injector 25. The electronic control unit 40 performs driving control of the ammonia injector 22 and the diesel fuel injector 25 to thereby control the amount of injection of ammonia and the amount of injection of diesel fuel, thereby controlling the distribution of injection (distribution of usage) of ammonia and diesel fuel. While FIG. 9 illustrates an example in which the exhaust temperature sensor 44 detects the temperature Te of exhaust gas after (downstream of) the exhaust catalyst 30, it is also possible to detect the temperature Te of exhaust gas before (upstream of) the exhaust catalyst 30.

In the present embodiment, as in the previous embodiments, the electronic control unit 40 stops injection of ammonia from the ammonia injector 22 and allows injection of diesel fuel from the diesel fuel injector 25 during the start of the internal combustion engine 10. Even after the start of the internal combustion engine 10, if the temperature Tw of cooling water which is detected by the cooling water temperature sensor 42 is equal to or lower than the ammonia injection allowable temperature T0, the electronic control unit 40 stops injection of ammonia from the ammonia injector 22 and allows injection of diesel fuel from the diesel fuel injector 25. Further, when the temperature Te of exhaust gas which is detected by the exhaust temperature sensor 44 is equal to or lower than the ammonia injection allowable temperature T1 after the start of the internal combustion engine 10, the electronic control unit 40 also stops injection of ammonia from the ammonia injector 22 and allows injection of diesel fuel from the diesel fuel injector 25. When the temperature Tw of cooling water rises to exceed the ammonia injection allowable temperature T0 and the temperature Te of exhaust gas rises to exceed the ammonia injection allowable temperature T1, the electronic control unit 40 then allows the use of ammonia and causes the ammonia injector 22 and the diesel fuel injector 25 to inject ammonia and diesel fuel, respectively. In this manner, it is possible to realize a stable operation with suppressed variations of combustion of the internal combustion engine 10 and also to suppress emission of unburned ammonia in a stable manner.

In each of the above embodiments, it is also possible to use ethanol (alcoholic fuel) as a combustion-supporting fuel. Because the octane number of ethanol is higher than that of gasoline, in the case of using ethanol as a combustion-supporting fuel, knock resistance can be enhanced in conjunction with the use of ammonia, thereby achieving a higher compression ratio. In addition, it is also possible to use a plurality of types of fuels as a combustion-supporting fuel, and a hydrocarbon fuel (such as gasoline or diesel fuel), hydrogen, and an alcoholic fuel (such as ethanol) can be used in combination, for example. All of hydrogen, gasoline, diesel fuel, and ethanol are easier to ignite than ammonia, and the combustion rates thereof are higher than that of ammonia. Accordingly, these are preferable combustion-supporting fuels for increasing the combustion rate of ammonia.

While some examples for implementing the present invention have been described, the present invention is not limited to these examples. It is therefore obvious that the present invention can be implemented in various forms without departing from the scope of the present invention.

1. A controller for an internal combustion engine for controlling an internal combustion engine which utilizes, as a fuel, ammonia and a combustion-supporting fuel for promoting combustion of the ammonia,
the controller comprising:
a cooling liquid temperature acquiring unit which acquires a temperature of a cooling liquid for the internal combustion engine; and
a fuel controlling unit which inhibits use of the ammonia when the temperature of the cooing liquid acquired by the cooling liquid temperature acquiring unit is a predetermined temperature or lower.

2. A controller for an internal combustion engine for controlling an internal combustion engine which utilizes, as a fuel, ammonia and a combustion-supporting fuel for promoting combustion of the ammonia,
the controller comprising:
a fuel controlling unit which inhibits use of the ammonia during start of the internal combustion engine.

3. A controller for an internal combustion engine for controlling an internal combustion engine which utilizes, as a fuel, ammonia and a combustion-supporting fuel for promoting combustion of the ammonia and which purifies ammonia contained in an exhaust gas by an exhaust purification device,
the controller comprising:
an exhaust temperature acquiring unit which acquires a temperature of the exhaust gas before or after the exhaust purification device; and
a fuel controlling unit which inhibits use of the ammonia when the temperature of the exhaust gas acquired by the exhaust temperature acquiring unit is a predetermined temperature or lower.

4. The controller for an internal combustion engine according to claim 1, wherein
the combustion-supporting fuel includes any one or more of hydrogen, a hydrocarbon fuel, and an alcohol fuel.

5. The controller for an internal combustion engine according to claim 2, wherein
the combustion-supporting fuel includes any one or more of hydrogen, a hydrocarbon fuel, and an alcohol fuel.

6. The controller for an internal combustion engine according to claim 3, wherein
the combustion-supporting fuel includes any one or more of hydrogen, a hydrocarbon fuel, and an alcohol fuel.
